(19) United States
(12) Patent Application Publication
(10) Pub. No.: US 2025/0157720 A1
(43) Pub. Date: May 15, 2025

(54) LAMINATED INDUCTOR

(71) Applicant: Murata Manufacturing Co., Ltd., Kyoto-fu (JP)

(72) Inventors: Takashi TOMOHIRO, Nagaokakyo-shi (JP); Yoshiko BANNO, Nagaokakyo-shi (JP)

(73) Assignee: Murata Manufacturing Co., Ltd., Kyoto-fu (JP)

(21) Appl. No.: 18/937,728

(22) Filed: Nov. 5, 2024

(30) Foreign Application Priority Data
Nov. 10, 2023 (JP) 2023-192414

(51) Int. Cl. H01F 27/28; H01F 27/06

(52) U.S. Cl. CPC H01F 27/2804; H01F 27/06; H01F 27/2852; H01F 2027/2809

(57) ABSTRACT

A laminated inductor having improved electrical characteristics by optimizing the shape of a through conductor in plan view. A laminated inductor includes an element body having magnetic layers laminated therein and having a hexahedron shape; external electrodes at at least each of four corners of a bottom surface of the element body; a composite coil including a first coil in which conductor layers in the element body are connected in a lamination direction and which has a winding axis in the lamination direction, and a second coil which is above the first coil in the lamination direction, in which conductor layers in the element body are connected in the lamination direction, and which has a winding axis in the lamination direction; and through conductors extending in the lamination direction from on the external electrodes and connected to both ends of the first and second coils.

### CROSS-REFERENCE TO RELATED APPLICATION

This application claims benefit of priority to Japanese Patent Application No. 2023-192414, filed Nov. 10, 2023, the entire content of which is incorporated herein by reference.

### BACKGROUND

### Technical Field

The present disclosure relates to a laminated inductor.

### Background Art

Japanese Patent Application Laid-Open No. 2019-176109 discloses a passive component (coil component) including an internal conductor built in a base part, an external electrode provided on a mounting surface of the base part and electrically connected to the internal conductor, and a lead conductor connecting the internal conductor and the external electrode, in which the lead conductor has a circular shape in plan view.

### SUMMARY

In the coil component described in Japanese Patent Application Laid-Open No. 2019-176109, when the diameter of the circular lead conductor (for example, a through conductor) in plan view is increased, the DC resistance decreases, but the volume of the base part decreases, and the inductance value of the coil component decreases.

In addition, when the diameter of the lead conductor is reduced, the inductance value is improved, but the resistance of the lead conductor, the connection resistance between the lead conductor and the internal conductor, and/or the connection resistance between the lead conductor and the external electrode are increased, so that the DC resistance as the coil component is increased. Furthermore, when the diameter of the lead conductor is small, the connection area between the lead conductor and the external electrode is reduced, which may cause a problem in connection reliability.

In view of the above, the present disclosure provides a laminated inductor in which the electrical characteristics of the inductance value and the DC resistance are further improved and the reliability is excellent by optimizing the shape of the through conductor in plan view.

A laminated inductor according to the present disclosure includes an element body having magnetic layers laminated therein and having a hexahedron shape; external electrodes provided at at least each of four corners of a bottom surface of the element body; a composite coil including a first coil in which a plurality of conductor layers disposed in the element body are connected in a lamination direction and which has a winding axis in the lamination direction, and a second coil which is positioned above the first coil in the lamination direction, in which a plurality of conductor layers disposed in the element body are connected in the lamination direction, and which has a winding axis in the lamination direction; and through conductors extending in the lamination direction from on the external electrodes and connected to both ends of the first coil and both ends of the second coil each. A shape of each of the through conductors is a triangular shape in which two sides constituting an outer edge of each of the through conductors are along an outer edge of the element body in plan view.

According to the present disclosure, since the shape of the through conductor is optimized in plan view, it is possible to further improve electrical characteristics and provide a laminated inductor having excellent reliability. Specifically, since the shape of the through conductor is a triangular shape in which two sides constituting the outer edge of the through conductor are along the outer edge of the element body in plan view, it is possible to appropriately provide the through conductor by effectively utilizing the region between the outer edge of the element body and the outer edge of the composite coil. Therefore, the connection area between the through conductor and the external electrode can be increased, and the DC resistance of the laminated inductor can be further reduced. In addition, the connection reliability between the through conductor and the external electrode can be further improved.

### BRIEF DESCRIPTION OF THE DRAWINGS

FIG. 1 is a perspective view schematically illustrating an example of a laminated inductor according to the present disclosure;

FIG. 2 is a perspective view schematically illustrating an example of an internal structure of the laminated inductor according to the first embodiment;

FIG. 3 is an exploded perspective view schematically illustrating an example of an internal structure of the laminated inductor according to the first embodiment;

FIG. 4A is a plan perspective view of the laminated inductor according to the first embodiment;

FIG. 4B is a plan perspective view of a modification of the laminated inductor according to the first embodiment;

FIG. 5 is a perspective view schematically illustrating an example of an internal structure of a laminated inductor according to a second embodiment;

FIG. 6 is a plan perspective view of the laminated inductor according to the second embodiment;

FIG. 7 is a perspective view schematically illustrating an example of an internal structure of a laminated inductor according to a third embodiment;

FIG. 8A is a plan perspective view of the laminated inductor according to the third embodiment; and

FIG. 8B is a plan perspective view of a modification of the laminated inductor according to the third embodiment.

### DETAILED DESCRIPTION

A laminated inductor according to the present disclosure will be described below. Note that the present disclosure is not limited to the following configuration, and may be appropriately changed without departing from the gist of the present disclosure. The present disclosure also includes a combination of a plurality of preferred configurations described below.

The laminated inductor of the present disclosure is used, for example, as a power inductor of a DC-DC converter. The laminated inductor of the present disclosure is also applicable to applications other than power inductors.

In the present specification, the term (for example, “parallel”, “orthogonal”, and the like) indicating a relationship between elements and the term indicating a shape of an element not only mean only a strictly literal aspect, but also mean a range including a substantially equivalent range, for example, a difference of about several %. In the present specification, a direction in which the magnetic layer and the coil conductor constituting the element body are laminated is referred to as a “lamination direction”. In addition, the plan view refers to a plan view of the element body as viewed from the upper surface (height direction).

The drawings shown below are schematic views, and dimensions, scales of aspect ratios, and the like may be different from those of an actual product.

### <Laminated Inductor of First Embodiment>

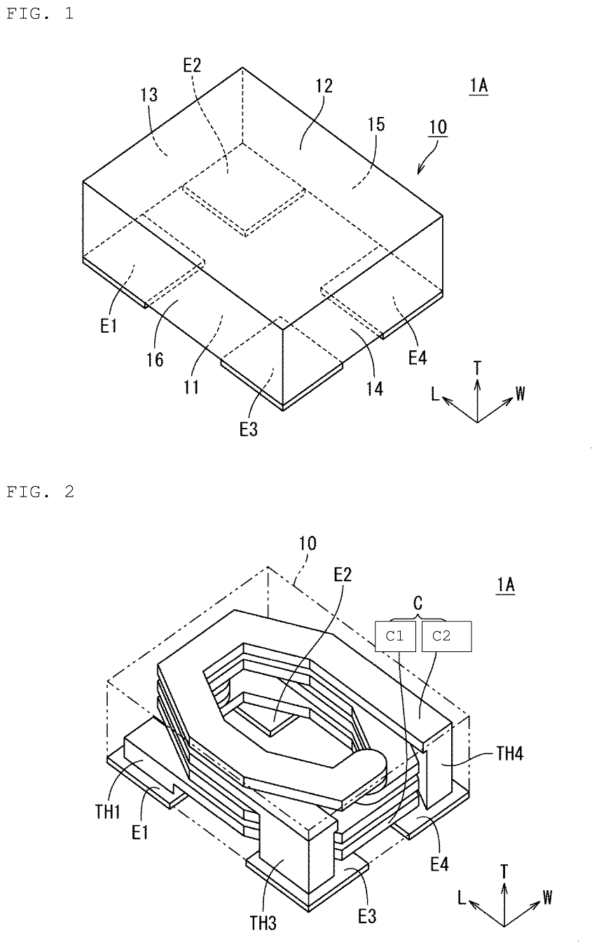

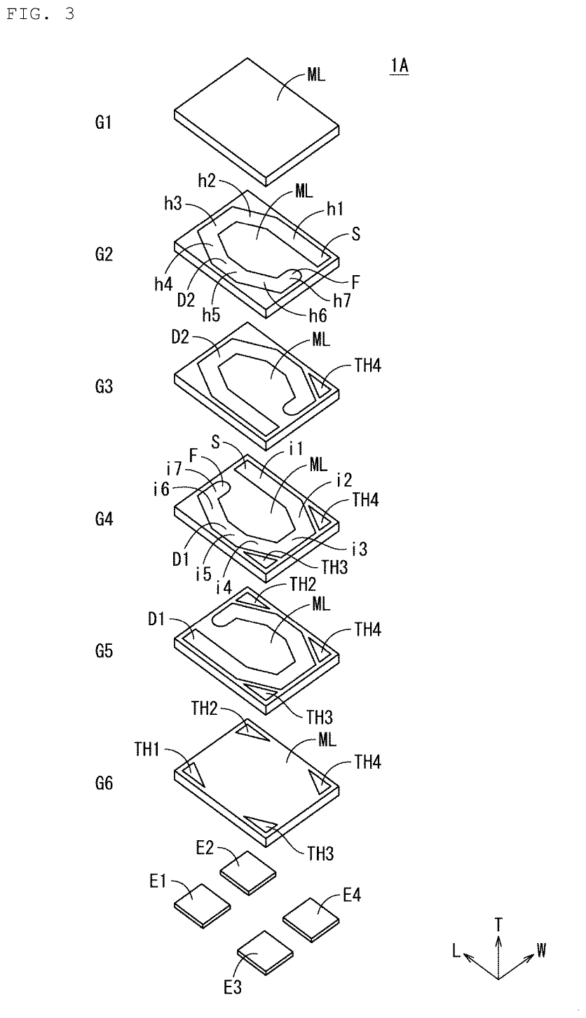

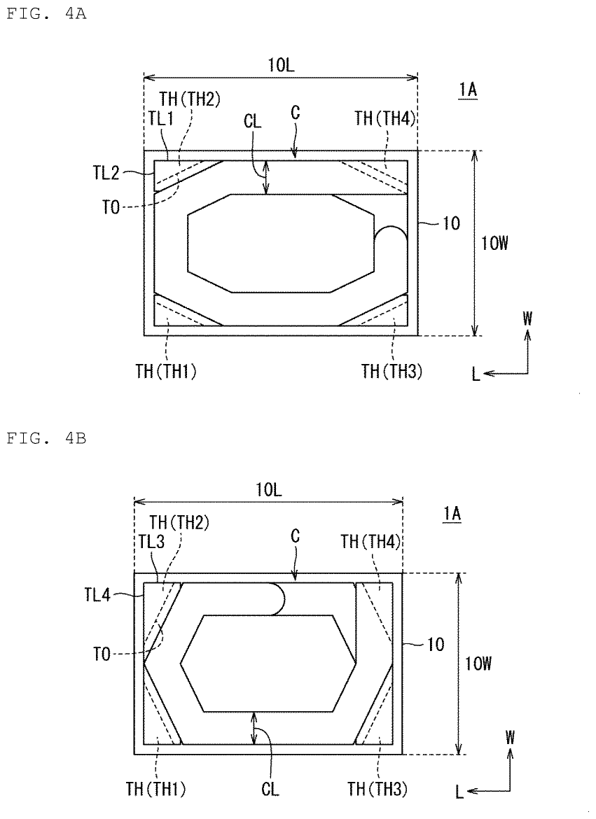

First, an embodiment of a laminated inductor according to a first embodiment of the present disclosure will be described with reference to FIGS. 1 to 4B. FIG. 1 is a perspective view schematically illustrating an example of a laminated inductor according to the present disclosure, FIG. 2 is a perspective view schematically illustrating an example of an internal structure of the laminated inductor according to the first embodiment, FIG. 3 is an exploded perspective view schematically illustrating an example of an internal structure of the laminated inductor according to the first embodiment, FIG. 4A is a plan perspective view of the laminated inductor according to the first embodiment, and FIG. 4B is a plan perspective view of a modification of the laminated inductor according to the first embodiment.

As illustrated in FIGS. 1 to 4B, a laminated inductor 1A includes an element body 10, external electrodes E (first external electrode E1 to fourth external electrode E4), a composite coil C (first coil C1 and second coil C2), and through conductors TH (first through conductor TH1 to fourth through conductor TH4). Hereinafter, each component will be described in detail with items.

### —Element Body—

The element body 10 has, for example, a hexahedron shape having six faces. As an example, the shape may be a rectangular parallelepiped shape or a substantially rectangular parallelepiped shape. The element body 10 may have corner portions and ridge portions rounded. The corner portion is a portion where three surfaces of the element body 10 intersect, and the ridge portion is a portion where two surfaces of the element body 10 intersect.

In FIG. 1, the long side direction, the short side direction, and the height direction of the laminated inductor 1A and the element body 10 are indicated as an L direction, a W direction, and a T direction, respectively. The long side direction L, the short side direction W, and the height direction T are orthogonal to each other.

The element body 10 illustrated in FIG. 1 includes a first main surface 11 and a second main surface 12 facing each other in the height direction T, a first end surface 13 and a second end surface 14 facing each other in the long side direction L, and a first side surface 15 and a second side surface 16 facing each other in the short side direction W. In the example shown in FIG. 1, each of the first external electrode E1, the second external electrode E2, the third external electrode E3, and the fourth external electrode E4 are formed at four corners of the first main surface 11 of the element body 10, and the first main surface 11 of the element body 10 corresponds to a mounting surface (bottom surface of the element body) of the laminated inductor 1A.

FIG. 3 is an exploded perspective view schematically illustrating an example of an internal structure of the laminated inductor according to the present disclosure. As illustrated in FIG. 3, the element body 10 is configured by laminating a plurality of magnetic layers ML in the height direction. Then, a first coil C1 having a first conductor layer D1 and a second coil C2 having a second conductor layer D2 to be described later may be provided inside the element body 10. In the present embodiment, as shown in FIG. 3, the element body 10 is configured by laminating lamination groups G1 to G6 and forming the first external electrode E1 to the fourth external electrode E4 on the lower side of the lamination group G6. The boundary of each layer of the laminated structure of the element body 10 may disappear. In addition, each of the lamination groups G1 to G6 may be configured by laminating a plurality of the same patterns.

### (Lamination Group G1)

The lamination group G1 includes the magnetic layer ML, and may constitute the second main surface 12 of the element body 10.

### (Lamination Group G2)

The lamination group G2 may include the magnetic layer ML and the second conductor layer D2.

The second conductor layer D2 of the lamination group G2 may include a portion h1 disposed along the long side of the element body 10 from one end S, a portion h2 disposed to be inclined at a predetermined angle from the end of the portion h1, a portion h3 disposed along the short side of the element body 10 from the end of the portion h2, a portion h4 disposed to be inclined at a predetermined angle from the end of the portion h3, a portion h5 disposed along the long side of the element body 10 from the end of the portion h4, a portion h6 disposed to be inclined at a predetermined angle from the end of the portion h5, and a portion h7 disposed along the short side of the element body 10 from the end of the portion h6, where the end corresponding to the winding start is the one end S and the end corresponding to the winding end is other end F. The one end S may be electrically connected to the fourth through conductor TH4 of the lamination group G3, and the other end F may be electrically connected to the second conductor layer D2 of the lamination group G3 via a via hole conductor (not illustrated).

### (Lamination Group G3)

The lamination group G3 may include a magnetic layer ML, a second conductor layer D2, and a fourth through conductor TH4.

The second conductor layer D2 of the lamination group G3 corresponds to the second conductor layer D2 of the lamination group G2 described above. In the top perspective view, at least part of the second conductor layer D2 of the lamination group G3 may overlap the second conductor layer D2 of the lamination group G2. One end of the second conductor layer D2 may be electrically connected to the second conductor layer D2 of the lamination group G2 via a via hole conductor (not illustrated), and the other end of the second conductor layer D2 may be electrically connected to the third through conductor TH3 of the lamination group G4. The second conductor layers D2 in the lamination groups G2 and G3 have a substantially octagonal shape in plan view. The substantially octagonal shape is mainly intended for a portion contributing to inductance characteristics, and does not include a connection portion with the through conductor.

The fourth through conductor TH4 of the lamination group G3 may be electrically connected to the fourth external electrode E4 by being connected to the fourth through conductor TH4 adjacent in the lamination direction. Therefore, the fourth through conductor TH4 may be disposed above the fourth external electrode E4. Details of the through conductor will be described later in detail with items.

### (Lamination Group G4)

The lamination group G4 may include a magnetic layer ML, a first conductor layer D1, a third through conductor TH3, and a fourth through conductor TH4.

The first conductor layer D1 of the lamination group G4 may include a portion i1 disposed along the long side of the element body 10 from the one end S, a portion i2 disposed to be inclined at a predetermined angle from the end of the portion i1, a portion i3 disposed along the short side of the element body 10 from the end of the portion i2, a portion i4 disposed to be inclined at a predetermined angle from the end of the portion i3, a portion i5 disposed along the long side of the element body 10 from the end of the portion i4, a portion i6 disposed to be inclined at a predetermined angle from the end of the portion i5, and a portion i7 disposed along the short side of the element body 10 from the end of the portion i6, where the end corresponding to the winding start is the one end S and the end corresponding to the winding end is the other end F. The one end S may be electrically connected to the second through conductor TH2 of the lamination group G5, and the other end F may be electrically connected to the first conductor layer D1 of the lamination group G5 via a via hole conductor (not illustrated).

The third through conductor TH3 and the fourth through conductor TH4 of the lamination group G4 may be electrically connected to the third through conductor TH3 and the fourth through conductor TH4 of the lamination group G5, respectively. Thus, the third through conductor TH3 may be disposed above the third external electrode E3 to be electrically connected to the third external electrode E3, and the fourth through conductor TH4 may be disposed above the fourth external electrode E4 to be electrically connected to the fourth external electrode E4.

### (Lamination Group G5)

The lamination group G5 may include a magnetic layer ML, a first conductor layer D1 configured by winding a conductor, a second through conductor TH2, a third through conductor TH3, and a fourth through conductor TH4.

The first conductor layer D1 of the lamination group G5 corresponds to the first conductor layer D1 of the lamination group G4 described above. In the top perspective view, at least part of the first conductor layer D1 of the lamination group G5 may overlap the first conductor layer D1 of the lamination group G4. One end of the first conductor layer D1 may be electrically connected to the first conductor layer D1 of the lamination group G4 via a via hole conductor (not illustrated), and the other end of the first conductor layer D1 may be electrically connected to the first through conductor TH1 of the lamination group G6. The first conductor layers D1 of the lamination groups G4 and G5 have a substantially octagonal shape in plan view.

The second through conductor TH2, the third through conductor TH3, and the fourth through conductor TH4 of the lamination group G5 may be electrically connected to the second through conductor TH2, the third through conductor TH3, and the fourth through conductor TH4 of the lamination group G6, respectively. As a result, the second through conductor TH2 may be disposed above the second external electrode E2 to be electrically connected to the second external electrode E2, the third through conductor TH3 may be disposed above the third external electrode E3 to be electrically connected to the third external electrode E3, and the fourth through conductor TH4 may be disposed above the fourth external electrode E4 to be electrically connected to the fourth external electrode E4.

### (Lamination Group G6)

The lamination group G6 may include a magnetic layer ML, a first through conductor TH1, a second through conductor TH2, a third through conductor TH3, and a fourth through conductor TH4. The areas of the first through conductors TH1 to the fourth through conductors TH4 in the lamination groups G1 to G6 in top view may be substantially the same.

### (Optional Additional Aspects of Lamination Group)

As a preferred aspect of the lamination group, an additional lamination group may be provided below the lamination group G6. The additional lamination group may include the first through conductors to the fourth through conductors having areas larger than the areas of the first through conductors TH1 to the fourth through conductors TH4 in the lamination groups G1 to G6 in top view. According to such a configuration, when the external electrode is disposed at a desired position of the element body, if the position of the through conductor is shrunk due to firing and deviated, connection failure does not occur. Since the additional lamination group is provided for buffering misalignment of the through conductors, the thickness thereof may be smaller than the thicknesses of the lamination groups G1 to G6.

The thicknesses of the first conductor layer D1 and/or the second conductor layer D2 in each lamination group may be the same. The first conductor layer D1, the second conductor layer D2, the first through conductor TH1 to the fourth through conductor TH4, and/or the via hole conductor may be metal conductors such as Ag and/or Cu as an example of the material, and the same kind of material or different kinds of materials may be used. The first conductor layer D1 and/or the second conductor layer D2, the first through conductor TH1 to the fourth through conductor TH4, and/or the via hole conductor may be formed by, for example, applying a conductive paste to the above-described magnetic layer ML, and printing the magnetic layer ML outside the conductive paste after applying the conductive paste.

As described above, when the element body 10 has a laminated structure including the lamination groups G1 to G6, the degree of freedom in designing the laminated inductor 1A is further increased. For example, when the laminated inductor 1A including the first external electrode E1 to the fourth external electrode E4 on the bottom surface (first main surface 11) of the element body 10 is manufactured, it is easy to extend the first conductor layer D1 and the second conductor layer D2 to the bottom surface side. In the laminated structure including the lamination groups G1 to G6, the material constituting the magnetic layer ML, the material constituting the first conductor layer D1 or the second conductor layer D2, and the material constituting the through conductor and/or the via hole conductor may be sequentially repeatedly printed by, for example, screen printing or the like from the second main surface 12 side or the first main surface 11 side of the element body 10 until the thickness becomes a desired thickness of the via hole conductor, and the laminated structure may be formed by a sputtering method, an inkjet method, or a known method other than these methods.

Further additional element relating to the element body 10 will be described. The magnetic layer ML may include metal magnetic grains made of a magnetic material. The metal magnetic grain may contain Fe and/or Si. More specifically, it may be Fe grain or Fe alloy grain. The Fe alloy may be a Fe—Si-based alloy, a Fe—Si—Cr-based alloy, a Fe—Si—Al-based alloy, a Fe—Si—B—P—Cu—C-based alloy, a Fe—Si—B—Nb—Cu-based alloy, or the like. In addition, the metal magnetic grain may contain impurities such as Cr, Mn, Cu, Ni, P, S, or Co which are not intended for production. The metal magnetic grain may be contained in the magnetic paste. Therefore, the metal magnetic grain may contain an element (for example, Cr, Al, Li, Zn, and Zr) that is more easily oxidized than Fe added at the time of preparing the magnetic paste.

The surface of the metal magnetic grains may be covered with an insulating film. When the surfaces of the metal magnetic grains are covered with the insulating film, the insulation between the metal magnetic grains can be improved, the withstand voltage of the inductor can be improved, and the eddy current generated in the metal magnetic grains can be suppressed. As a method for forming an insulating film on the surface of the metal magnetic grains, a sol-gel method, a mechanochemical method, or the like can be used. The material constituting the insulating film may be an oxide such as P or Si, zinc phosphate, or manganese phosphate. The insulating film may be an oxide film formed by oxidizing the surface of the metal magnetic grains with oxygen in the atmosphere, or an oxide film of an element more easily oxidized than Fe. The thickness of the insulating film is preferably 1 nm or more and 50 nm or less (i.e., from 1 nm to 50 nm), more preferably 1 nm or more and 30 nm or less (i.e., from 1 nm to 30 nm), and still more preferably 1 nm or more and 20 nm or less (i.e., from 1 nm to 20 nm). For example, a cross section obtained by polishing a sample of the inductor is photographed with a scanning electron microscope (SEM), and the thickness of the insulating film covering the surface of the metal magnetic grains can be measured from the obtained SEM photograph.

The average grain diameter of the metal magnetic grains in the magnetic layer ML is preferably 1 μm or more and 30 μm or less (i.e, from 1 μm to 30 μm), more preferably 1 μm or more and 20 μm or less (i.e., from 1 μm to 20 μm), and still more preferably 1 μm or more and m or less (i.e., from 1 μm to 10 μm). The average grain diameter of the metal magnetic grains in the magnetic layer can be measured by the procedure described below. The sample of the inductor is cut to obtain a sample cross section. Specifically, a sample cross section is obtained by cutting through the center portion of the element body so as to be orthogonal to the mounting surface and the end surface of the laminated inductor. For the obtained cross section, regions (for example, 130 μm×100 μm) at a plurality of locations (for example, 5 locations) are photographed with SEM, and the obtained SEM image is analyzed using image analysis software (for example, image analysis software WinROOF2021 (manufactured by MITANI CORPORATION)) to determine the equivalent circle diameter of the metal magnetic grains. The average value of the obtained equivalent circle diameters is taken as the average grain diameter of the metal magnetic grains.

When the element body 10 is formed, heat treatment is performed. In this case, the metal magnetic grains contained in the element body 10 each have an oxide film on the surface. This oxide film is derived from metal magnetic grains and is formed by heat treatment. In the element body 10, adjacent metal magnetic grains are bonded to each other with an oxide film interposed therebetween.

The element body 10 may be impregnated with a resin material after firing of the element body 10 in order to further improve the element body strength. As an example of the resin for enhancing the element body strength, an epoxy resin and/or a phenol resin and/or a silicone resin may be used.

### —External Electrode—

The external electrode E is provided on the bottom surface of the element body 10. The external electrode E includes a first external electrode E1, a second external electrode E2, a third external electrode E3, and a fourth external electrode E4. The first external electrode E1 and the second external electrode E2 may be electrically connected to the first conductor layer D1. The third external electrode E3 and the fourth external electrode E4 may be electrically connected to the second conductor layer D2. When the external electrode E is provided on the bottom surface (first main surface 11) of the element body 10, the laminated inductor 1A can be appropriately mounted on a mounting substrate or the like.

Each of the first external electrode E1 to the fourth external electrode E4 may be provided only on the first main surface 11 of the element body 10, but may be provided across the first main surface 11 of the element body 10 and a surface (any one or two surfaces of the first end surface 13, the second end surface 14, the first side surface 15, and the second side surface 16) adjacent to the first main surface 11.

As a preferred aspect of the external electrode E, the plane area of the external electrode E as viewed from the mounting surface side of the laminated inductor 1A may be larger than the plane area of the first through conductor TH1 to the fourth through conductor TH4 of the lamination group G6. By making the plane area of the external electrode E larger than that of the first through conductor TH1 to the fourth through conductor TH4 of the lamination group G6, alignment at the time of electrical connection between the through conductor and the external electrode can be easily performed.

As an example, various materials such as Cu and/or Au may be used for the external electrode E. The external electrode E may be formed by any method. As an example, the external electrode E may be a plated electrode formed by plating (for example, an electroless plating method or a sputtering method). After the external electrode E is formed, a plated layer of Ni, Sn, or the like is further formed on the external electrode E by a plating method to form a laminated structure of two or more layers.

### —Composite Coil—

The composite coil C includes a first coil C1 and a second coil C2.

As a preferable aspect of the composite coil, the winding shape of the composite coil C may be, for example, an octagonal shape as illustrated in FIG. 4A in plan view. As an example, the shape of the contour (inner contour and/or outer contour) of the composite coil C may be an octagonal shape. The term “octagonal shape” as used herein is not limited to an octagonal shape in a strict sense, but is intended to include a substantially octagonal shape having a configuration corresponding to eight sides or eight corners. For example, a case where eight corners protrude from a side, are rounded, or are flat, or a case where eight sides are curved and/or bent may be included. By forming the shape of the composite coil C to an octagonal shape or a shape similar thereto, a substantially triangular region can be provided between the outer peripheral edge of the composite coil C and the element body 10, and a through conductor TH to be described later can be appropriately provided in the region.

As illustrated in FIG. 4B, the winding shape of the composite coil C may be a hexagonal shape in plan view. As an example, the shape of the contour (inner contour and/or outer contour) of the composite coil C may be a hexagonal shape. The term “hexagonal shape” as used herein is not limited to a hexagonal shape in a strict sense, but is intended to include a substantially hexagonal shape having a configuration corresponding to six sides or six corners. For example, a case where six corners protrude from a side, are rounded, or are flat, or a case where six sides are curved and/or bent may be included. If the shape of the composite coil C is a hexagonal shape or a similar shape, a substantially triangular region can be provided between the outer peripheral edge of the composite coil C and the element body 10, and a through conductor TH to be described later can be appropriately provided in the region.

In the first coil C1, the plurality of first conductor layers D1 disposed in the element body 10 are connected in the lamination direction, and the first coil C1 has a winding axis in the lamination direction. As an example, as described above, the first coil C1 may be provided over two lamination groups (lamination groups G4, G5). Accordingly, the first coil C1 may have 1.75 turns.

The second coil C2 is located above the first coil C1 in the lamination direction, the plurality of second conductor layers D2 disposed in the element body 10 are connected in the laminating direction, and the second coil C2 has a winding axis in the laminating direction. As an example, the second coil C2 may be provided over two lamination groups (lamination groups G2, G3). Accordingly, the second coil C2 may have 1.75 turns.

### —Through Conductor—

The through conductor extends from on the external electrode in the lamination direction, and is connected to both ends of the first coil C1 and both ends of the second coil C2. In the present embodiment, the first through conductor TH1 to the fourth through conductor TH4 may be provided.

The first through conductor TH1 may electrically connect the end of the first coil C1 closest to the bottom surface (first main surface 11) of the element body 10 in the first coil C1 and the first external electrode E1. The second through conductor TH2 may electrically connect the other end of the first coil C1 and the second external electrode E2. The third through conductor TH3 may electrically connect the end of the second coil C2 closest to the bottom surface (first main surface 11) of the element body 10 in the second coil C2 and the third external electrode E3. The fourth through conductor TH4 may connect the other end of the second coil C2 and the fourth external electrode E4.

The shape of the through conductor is a triangular shape in which two sides are along the outer edge of the element body 10 in plan view. As an example, the shape of the outer contour of the through conductor may be a triangular shape. The term “triangular shape” as used herein is not limited to a triangular shape in a strict sense, and is intended to include a substantially triangular shape having a configuration corresponding to three sides or three corners. For example, a case where three corners protrude from a side, are rounded, or are flat, or a case where three sides are curved and/or bent may be included. Therefore, according to the laminated inductor 1A of the present disclosure, the through conductor TH can be appropriately provided by effectively utilizing the region between the outer edge of the element body 10 and the outer edge of the composite coil C. As a result, the connection area between the through conductor TH and the external electrode E can be increased, and the DC resistance of the laminated inductor 1A can be further reduced. In addition, the connection reliability between the through conductor TH and the external electrode E can be further improved.

As a suitable shape of the through conductor, lengths of two sides of the through conductor TH may be different from each other in plan view. As an example, in the laminated inductor 1A illustrated in FIG. 4A, a side TL1 along the long side of the element body 10 in the through conductor TH is longer than a side TL2 along the short side of the element body 10 in the through conductor TH. According to such an aspect, the through conductor TH can be appropriately provided corresponding to the shape of the region between the outer edge of the element body 10 and the outer edge of the composite coil C. As in the laminated inductor 1A illustrated in FIG. 4B, the side TL3 along the long side of the element body 10 in the through conductor TH may be shorter than the side TL4 along the short side of the element body 10 in the through conductor TH. According to such an aspect as well, the through conductor TH can be appropriately provided corresponding to the shape of the region between the outer edge of the element body 10 and the outer edge of the composite coil C.

In addition, as a preferred aspect of the through conductor, in plan view, the oblique side TO of the through conductor TH may be parallel to one side of the outer edge of the composite coil C in plan view. The “oblique side of the through conductor” as used herein means a side different from two sides along the outer edge of the element body 10 in the triangular through conductor TH. According to such an aspect, the interval between the through conductor TH and the composite coil C becomes constant, and the through conductor TH as large as possible can be provided in the region between the outer edge of the element body 10 and the outer edge of the composite coil C.

In addition, as a preferred aspect of the through conductor, the shape of the through conductor TH in plan view may be a right-angled scalene triangular shape. The “right-angled scalene triangular shape” used herein means a triangle in which the lengths of three sides constituting the triangle are different from each other and one angle of the triangle is a right angle. The term “right angle” used herein does not need to strictly constitute 90°, and may include an error of about ±5°. As described above, by forming the shape of the through conductor TH into a right-angled triangular shape in which the lengths of the three sides are different, the degree of freedom of the lengths of the three sides of the triangle is increased, and the through conductor TH can be appropriately provided in the region between the outer edge of the element body 10 and the outer edge of the composite coil C.

In addition, as a preferred aspect of the through conductor, the ratio of the long sides TL1 (see FIG. 4A) and TL4 (see FIG. 4B) and the short sides TL2 (see FIG. 4A) and TL3 (see FIG. 4B) constituting the right angle of the right-angled scalene triangle may correspond to the ratio of the long side 10L and the short side 10W constituting the outer edge of the element body 10 in plan view. More specifically, the ratio of the lengths of the long sides TL1 and TL4 and the short sides TL2 and TL3 constituting the right angle of the right-angled scalene triangle may be equal to (or the same as) the ratio of the lengths of the long side 10L and the short side 10W constituting the outer edge of the element body 10 in plan view. When the long side dimension and the short side dimension of the element body 10 and the long side dimension and the short side dimension of the through conductor TH are designed in this manner, the balance between the magnetic flux inside the composite coil C and the magnetic flux outside the composite coil C is improved, and the inductance value can be increased.

In addition, as a preferred aspect of the through conductor TH, the dimensions of the short sides TL2 and TL3 constituting the right angle of the right-angled scalene triangle may be smaller than the width dimension CL of the composite coil C in plan view, and the dimensions of the long sides TL1 and TL4 constituting the right angle of the right-angled scalene triangle may be smaller than ½ of the dimension of the short side 10W constituting the outer edge of the element body 10 in plan view. By setting the dimensions of the short sides TL2 and TL3 of the through conductor TH to be equal to or larger than the width dimension CL of the composite coil C, the connection area between the through conductor TH and the composite coil C can be increased, and the connection reliability between the composite coil C and the through conductor TH can be enhanced. In addition, by setting the dimensions of the long sides TL1 and TL4 of the through conductor TH to be smaller than ½ of the dimension of the short side 10W of the element body 10, the composite coil C having a large plane area can be built in the element body 10, so that the inductance value can be increased. Here, the width dimension CL refers to a minimum width at one side of the coil winding where the oblique sides of the right-angled scalene triangle are adjacent.

### <Laminated Inductor of Second Embodiment>

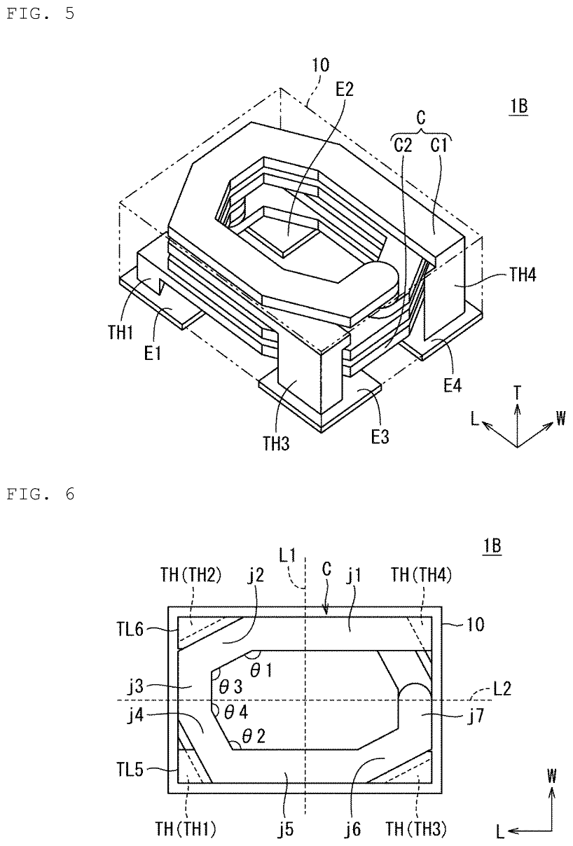

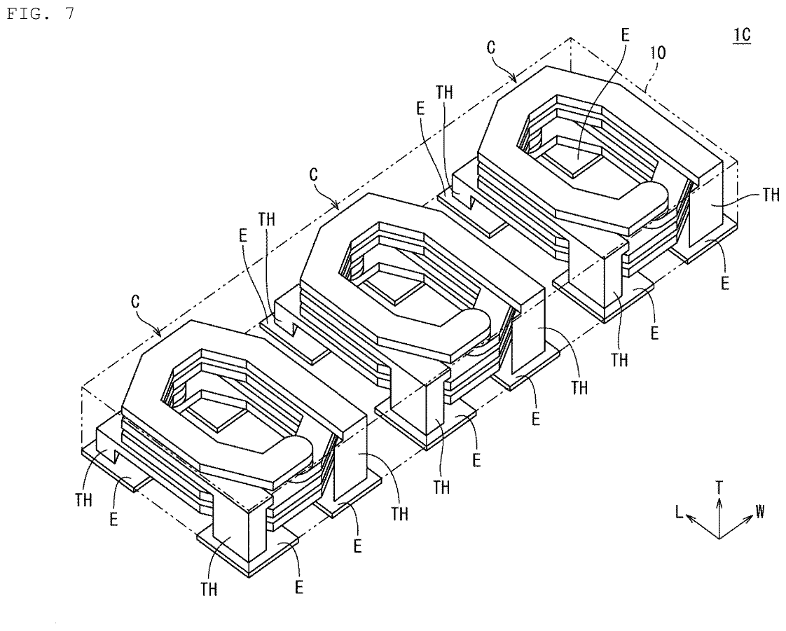

Next, a laminated inductor 1B according to a second embodiment will be described with reference to FIGS. 5 and 6. FIG. 5 is a perspective view schematically illustrating an example of an internal structure of a laminated inductor according to the second embodiment, and FIG. 6 is a plan perspective view of the laminated inductor according to the second embodiment. The laminated inductor 1B of the second embodiment is different from the laminated inductor 1A of the first embodiment described above in the internal structure of the element body 10. In the following description, differences from the laminated inductor described in the above embodiment will be mainly described.

### —Composite Coil—

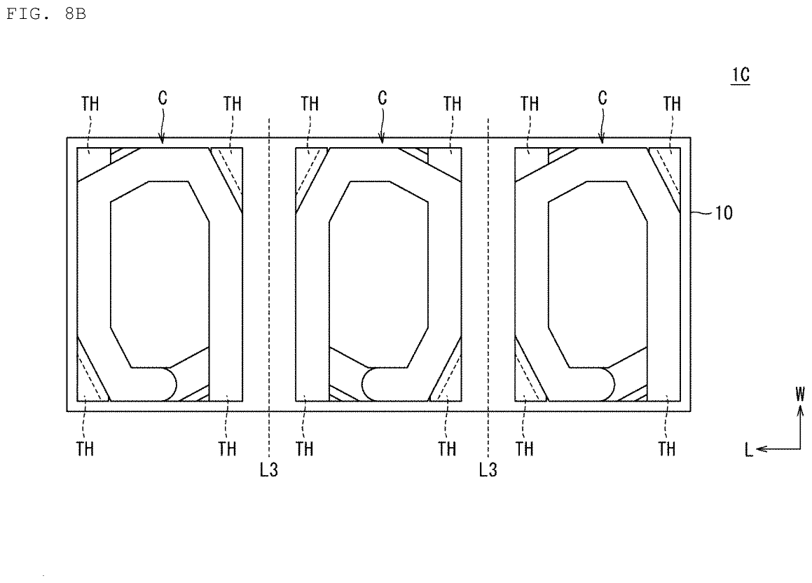

The composite coil C of the present embodiment may be point-symmetric with respect to the center of the element body. In FIG. 6 illustrating an example, the composite coil C in plan view is point-symmetric with respect to an intersection of a virtual straight line L1 and a virtual straight line L2 that pass through the center of the element body 10 and are parallel to the outer edge of the element body 10. When the composite coil C is point-symmetric in plan view, the magnetic flux formed inside the composite coil C can be more dispersed than the laminated inductor 1A of the first embodiment. The dispersion of the magnetic flux is useful, for example, in the case of the configuration of a laminated inductor 1C of the third embodiment illustrated in FIG. 8B to be described later because the locations where the magnetic flux concentrates can be prevented from being aligned by alternately arranging the composite coils C. When the above configuration is specified from another viewpoint, the composite coil C in plan view may be non-line-symmetric with respect to the virtual straight line L1 and the virtual straight line L2.

As a more specific aspect (see FIG. 6) of the composite coil C, a portion j1 arranged along the long side of the element body 10, a portion j2 arranged to be inclined at a predetermined angle from the end of the portion j1, a portion j3 arranged along the short side of the element body 10 from the end of the portion j2, a portion j4 arranged to be inclined at a predetermined angle from the end of the portion j3, a portion j5 arranged along the long side of the element body 10 from the end of the portion j4, a portion j6 arranged to be inclined at a predetermined angle from the end of the portion j5, and a portion j7 arranged along the short side of the element body 10 from the end of the portion j6 may be included. The angle θ1 formed by the portion j1 and the portion j2 and the angle θ2 formed by the portion j5 and the portion j4 may be different from each other. In addition, the angle θ3 formed by the portion j3 and the portion j2 and the angle θ4 formed by the portion j3 and the portion j4 may be different from each other. Although the above description assumes an octagonal composite coil in plan view, the winding shape of the composite coil may be a hexagonal shape in plan view.

### —Through Conductor—

In the through conductor TH of the present embodiment, two through conductors (for example, the first through conductor TH1 and the second through conductor TH2) arranged along one side of the outer edge of the element body 10 may have a shape in which the through conductors TH are rotated by 90° from each other in plan view. In FIG. 6 illustrating an example, the two through conductors may have a shape in which a short side (for example, the short side TL6 of the second through conductor TH2) of one through conductor may be disposed on an extension line of a long side (for example, the long side TL5 of the first through conductor TH1) of the other through conductor. When each through conductor has such a shape, the through conductor TH can be appropriately provided in the region between the point-symmetric and non-line-symmetric composite coil C and the element body 10 described above.

### <Laminated Inductor of Third Embodiment>

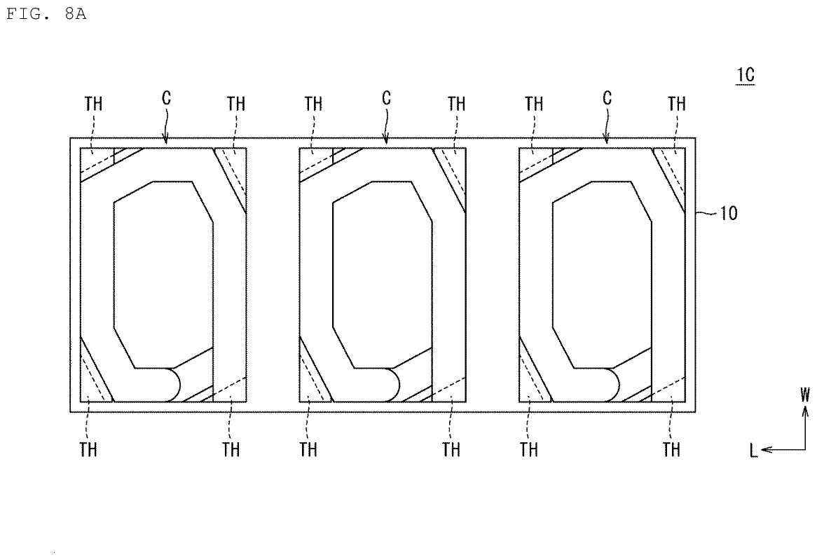

Next, a laminated inductor according to a third embodiment will be described with reference to FIGS. 7 to 8B. FIG. 7 is a perspective view schematically illustrating an example of an internal structure of a laminated inductor according to a third embodiment, FIG. 8A is a plan perspective view of the laminated inductor according to the third embodiment, and FIG. 8B is a plan perspective view of a modification of the laminated inductor according to the third embodiment. The laminated inductor 1C of the third embodiment is different from the laminated inductor 1A of the first embodiment and the laminated inductor 1B of the second embodiment described above in that a plurality of composite coils C are provided in the element body 10. In the following description, differences from the laminated inductor described in the above embodiment will be mainly described.

In the laminated inductor 1C of the third embodiment, a plurality of composite coils C may be provided in the element body 10, and one composite coil C may be disposed in a direction intersecting the lamination direction with respect to the other composite coil C in plan view. In addition, the laminated inductor 1C of the third embodiment may correspond to a plurality of composite coils C, and a plurality of through conductors TH and a plurality of external electrodes E may also be provided. In FIGS. 7 and 8A illustrating an example, three composite coils C may be disposed in the W direction (direction intersecting the lamination direction). 12 through conductors TH and 12 external electrodes E may be provided corresponding to the three composite coils C. The composite coils C arranged in the W direction may have substantially the same structure.

As in the laminated inductor 1C of the third embodiment, by providing a plurality of the composite coils C in the element body 10 in the direction intersecting the lamination direction, it is possible to contribute to an increase in current and high efficiency of the DC-DC converter.

Furthermore, as a modification of the laminated inductor 1C of the third embodiment, one composite coil C and the other composite coil C may be alternately arranged in a direction intersecting the lamination direction in plan view (see FIG. 8B). The term “alternately” as used herein means that when a virtual straight line L3 bisecting one composite coil C and the other composite coil C is drawn, the virtual straight line L3 is line-symmetric with respect to the virtual straight line L3. Specifically, they are intended to overlap each other when folded along the virtual straight line L3. According to such a modification of the third embodiment, unlike the laminated inductor illustrated in FIG. 8A, it is possible to prevent a place where the magnetic flux concentrates in one composite coil C and a place where the magnetic flux concentrates in the other composite coil C from being matched with each other. Therefore, by preventing alignment of the positions where the magnetic fluxes are concentrated, interference between one composite coil and the other composite coil can be reduced, and a laminated inductor in which inductance characteristics are further improved can be obtained.

In addition, as in the laminated inductor illustrated in FIG. 8B, in plan view, the through conductors TH connected to one composite coil C and the through conductors TH connected to the other composite coil C may be alternately arranged in a direction intersecting the lamination direction. According to such a modification of the third embodiment, the through conductors TH can be appropriately arranged in the region between the composite coil C and the element body 10 arranged alternately.

Note that the embodiments disclosed herein are considered by way of illustration in all respects, and not considered as a basis for restrictive interpretations. Therefore, the technical scope of the present disclosure is not to be construed only by the above-described embodiments, but is defined based on the description of the claims. Further, the technical scope of the present disclosure includes meanings equivalent to the claims and all modifications within the scope.

An aspect of the laminated inductor of the present disclosure is as follows.
<1> A laminated inductor including an element body having magnetic layers laminated therein and having a hexahedron shape; external electrodes provided at at least each of four corners of a bottom surface of the element body; a composite coil including a first coil in which a plurality of conductor layers disposed in the element body are connected in a lamination direction and which has a winding axis in the lamination direction, and a second coil which is positioned above the first coil in the lamination direction, in which a plurality of conductor layers disposed in the element body are connected in the lamination direction, and which has a winding axis in the lamination direction; and through conductors extending in the lamination direction from on the external electrodes and connected to both ends of the first coil and both ends of the second coil each. A shape of each of the through conductors is a triangular shape in which two sides extend along an outer edge of the element body in plan view.
<2> The laminated inductor according to <1>, in which lengths of the two sides of the through conductor are different from each other in plan view.
<3> The laminated inductor according to <1> or <2>, in which one side of the through conductor different from the two sides of the through conductor is parallel to one side of an outer edge of the composite coil in plan view.
<4> The laminated inductor according to any one of <1> to <3>, in which a winding shape of the composite coil is a hexagonal shape or an octagonal shape in plan view.
<5> The laminated inductor according to any one of <1> to <4>, in which a shape of the through conductor in plan view is a right-angled scalene triangular shape.
<6> The laminated inductor according to <5>, in which a ratio of a long side and a short side constituting a right angle of the right-angled scalene triangle corresponds to a ratio of a long side and a short side constituting an outer edge of the element body in plan view.
<7> The laminated inductor according to <5> or <6>, in which a dimension of a short side constituting a right angle of the right angled scalene triangle is smaller than a width dimension of the composite coil in plan view, and a dimension of a long side constituting a right angle of the right-angled scalene triangle is smaller than ½ of a dimension of a short side constituting an outer edge of the element body in plan view.
<8> The laminated inductor according to any one of <1> to <7>, in which the two through conductors arranged along one side of the outer edge of the element body are in a positional relationship in which the through conductor is rotated by 90° in plan view.
<9> The laminated inductor according to <8>, in which the composite coil is point-symmetric with respect to the center of the element body in plan view.
<10> The laminated inductor according to any one of <1> to <9>, in which a plurality of the composite coils are provided in the element body, and the other composite coil is disposed in a direction intersecting the lamination direction with respect to the one composite coil in plan view.
<11> The laminated inductor according to <10>, in which the one composite coil and the other composite coil are alternately arranged in a direction intersecting the lamination direction in plan view.
<12> The laminated inductor according to <11>, in which the through conductor connected to the one composite coil and the through conductor connected to the other composite coil are alternately arranged in a direction intersecting the lamination direction in plan view.

The laminated inductor of the present disclosure can be suitably used as an electronic component with further improved electrical characteristics by optimizing the shape of the through conductor in plan view.

What is claimed is:

1. A laminated inductor comprising:
an element body having magnetic layers laminated therein and having a hexahedron shape;
external electrodes at at least each of four corners of a bottom surface of the element body;
at least one composite coil including a first coil in which a plurality of conductor layers in the element body are connected in a lamination direction and which has a winding axis in the lamination direction, and a second coil which is above the first coil in the lamination direction, in which a plurality of conductor layers in the element body are connected in the lamination direction, and which has a winding axis in the lamination direction; and
through conductors extending in the lamination direction from on the external electrodes and connected to both ends of the first coil and both ends of the second coil each,
wherein a shape of each of the through conductors is a triangular shape in which two sides configuring an outer edge of each of the through conductors are along an outer edge of the element body in plan view.

2. The laminated inductor according to claim 1, wherein
lengths of the two sides of each of the through conductors are different from each other in plan view.

3. The laminated inductor according to claim 1, wherein
another side of each of the through conductors different from the two sides of the through conductor is parallel to one side of an outer edge of the composite coil in plan view.

4. The laminated inductor according to claim 1, wherein
a winding shape of the composite coil is a hexagonal shape or an octagonal shape in plan view.

5. The laminated inductor according to claim 1, wherein
a shape of each of the through conductors in plan view is a right-angled scalene triangular shape.

6. The laminated inductor according to claim 5, wherein
a ratio of a long side and a short side defining a right angle of the right-angled scalene triangle corresponds to a ratio of a long side and a short side defining an outer edge of the element body in plan view.

7. The laminated inductor according to claim 5, wherein
a dimension of a short side defining a right angle of the right-angled scalene triangle is smaller than a width dimension of the composite coil in plan view, and a dimension of a long side defining a right angle of the right-angled scalene triangle is smaller than ½ of a dimension of a short side defining an outer edge of the element body in plan view.

8. The laminated inductor according to claim 1, wherein
two of the through conductors arranged along one side of the outer edge of the element body have a shape in which the through conductor is rotated by 90° in plan view.

9. The laminated inductor according to claim 8, wherein
the composite coil is point-symmetric with respect to a center of the element body.

10. The laminated inductor according to claim 1, wherein
the at least one composite coil includes a plurality of the composite coils in the element body, and the one composite coil is in a direction intersecting the lamination direction with respect to an other composite coil in plan view.

11. The laminated inductor according to claim 10, wherein
the one composite coil and the other composite coil are alternately arranged in a direction intersecting the lamination direction in plan view.

12. The laminated inductor according to claim 11, wherein
the through conductor connected to the one composite coil and the through conductor connected to the other composite coil are alternately arranged in a direction intersecting the lamination direction in plan view.

13. The laminated inductor according to claim 2, wherein
the at least one composite coil includes a plurality of the composite coils in the element body, and
the one composite coil is in a direction intersecting the lamination direction with respect to an other composite coil in plan view.

14. The laminated inductor according to claim 3, wherein
the at least one composite coil includes a plurality of the composite coils in the element body, and
the one composite coil is in a direction intersecting the lamination direction with respect to an other composite coil in plan view.

15. The laminated inductor according to claim 4, wherein
the at least one composite coil includes a plurality of the composite coils in the element body, and
the one composite coil is in a direction intersecting the lamination direction with respect to an other composite coil in plan view.

16. The laminated inductor according to claim 5, wherein
the at least one composite coil includes a plurality of the composite coils in the element body, and
the one composite coil is in a direction intersecting the lamination direction with respect to an other composite coil in plan view.

17. The laminated inductor according to claim 6, wherein
the at least one composite coil includes a plurality of the composite coils in the element body, and
the one composite coil is in a direction intersecting the lamination direction with respect to an other composite coil in plan view.

18. The laminated inductor according to claim 7, wherein
the at least one composite coil includes a plurality of the composite coils in the element body, and
the one composite coil is in a direction intersecting the lamination direction with respect to an other composite coil in plan view.

19. The laminated inductor according to claim 8, wherein
the at least one composite coil includes a plurality of the composite coils in the element body, and
the one composite coil is in a direction intersecting the lamination direction with respect to an other composite coil in plan view.

20. The laminated inductor according to claim 9, wherein
the at least one composite coil includes a plurality of the composite coils in the element body, and
the one composite coil is in a direction intersecting the lamination direction with respect to an other composite coil in plan view.
